(19) United States
(12) Patent Application Publication
(10) Pub. No.: US 2025/0317445 A1
(43) Pub. Date: Oct. 9, 2025

(54) AUTHORIZING FEDERATED LEARNING

(71) Applicant: Nokia Technologies Oy, Espoo (FI)

(72) Inventors: Saurabh KHARE, Bangalore (IN); Chaitanya AGGARWAL, Munich (DE)

(21) Appl. No.: 18/863,424

(22) PCT Filed: May 9, 2023
(86) PCT No.: PCT/EP2023/062211

§ 371 Date: Nov. 6, 2024

(30) Foreign Application Priority Data
May 13, 2022 (IN) 202241027671

(51) Int. Cl. H04L 9/40

(52) U.S. Cl. CPC H04L 63/10

(57) ABSTRACT

A method comprising: checking whether an authorization for performing a federated learning of a model by a terminal is received from a first network element: monitoring whether a request for the performing the federated learning of the model by the terminal is received; and prohibiting the performing the federated learning of the model by the terminal if at least one of: the authorization for the federated learning of the model by the terminal is not received, and the request for the performing the federated learning of the model by the terminal is not received.

### FIELD OF THE INVENTION

The present disclosure relates to federated learning, in particular to its authorization.

### Abbreviations

3GPP 3^{rd} Generation Partnership Project
5G/6G/7G 5^{th}/6^{th}/7^{th} Generation
5GC 5^{th} Generation Core
ADRF Analytical Data Repository Function
AF Application Function
AI Artificial Intelligence
AMF Access and Mobility Management Function
CPU Central Processing Unit
CRM Customer Relationship Management
DB Database
FL Federated Learning
FLF Federated Learning Network Function
gNB Next Generation NodeB
ID Identifier
IoT Internet of Things
IVR Interactive Voice Response
ML Machine Learning
MTC Machine-type Communication
NAS Non-Access Stratum
NEF Network Exposure Function
SA System Architecture
SID Study Item
SMF Session Management Function
SMS Short Message Service
TR Technical Report
TS Technical Specification
UDM Unified Data Management
UDR Unified Data Repository
UE User Equipment
UPU UE Parameter Update

### BACKGROUND

Many applications in mobile networks require a large amount of data from multiple distributed sources like UEs or distributed gNBs to be used to train a single common model. To minimize the data exchange between the distributed units from where the data is generated and the centralized unit(s) where the common model needs to be created, the concept of Federated learning (FL) may be applied. FL is a form of machine learning where, instead of model training at a single node, different versions of the model are trained at the different distributed hosts. This is different from distributed machine learning, where a single ML model is trained at distributed nodes to use computation power of different nodes. In other words, FL is different from distributed learning in the sense that: 1) each distributed node in a FL scenario has its own local training data which may not come from the same distribution as the local training data at other nodes; 2) each node computes parameters for its local ML model and 3) the central host does not compute a version or part of the model but combines parameters of all the distributed models to generate a main model. The objective of this approach is to keep the training dataset where it is generated and perform the model training locally at each individual learner in the federation.

After training a local model, each individual learner transfers its local model parameters, instead of the (raw) training dataset, to an aggregating unit, e.g. an AF or a gNB. The aggregating unit utilizes the local model parameters to update a global model which may eventually be fed back to the local learners for further iterations until the global model converges. As a result, each local learner benefits from the datasets of the other local learners only through the global model, shared by the aggregator, without explicitly accessing high volume of (potentially privacy-sensitive) data available at each of the other local learners. This is illustrated in FIG. 1, where UEs serve as local learners and an AF (AF2) performs as an aggregating unit.

Summarizing, FL training process can be explained by the following main steps:
Initialization: A machine learning model (e.g., linear regression, neural network) is chosen to be trained on local nodes and initialized.
Client selection: a fraction of local nodes is selected to start training on local data. The selected nodes acquire the current statistical model while the others wait for the next federated round.
Reporting and Aggregation: each selected node sends its local model to the central function (may be hosted by a central server) for aggregation. The central function aggregates the received models and sends back the model updates to the nodes.
Termination: once a pre-defined termination criterion is met (e.g., a maximum number of iterations is reached), the central function aggregates the updates and finalizes the global model.

In 3GPP SA2 AIML, currently the following objectives are discussed:
The objectives of this study are to focus on identifying key issues, potential threats, requirements and solutions to enable:
   1. 5G system assistance for the security management (e.g., membership and group management) for Distributed/Federated learning, Splitting, Sharing and Model Distribution between application AI/ML endpoints (i.e. UEs and Application AI/ML service/model provider) which requires data transmission support for application layer AI/ML operation over the 5G system
   2. The authentication and authorization for third-party application or application functions to take part in application layer AI/ML operations that involves in UE and Network data collection and sharing, i.e. UE and network privacy protections to support application AI/ML services over 5G system.
   3. UE and 5G system to secure AI/ML based services and operations.
   4. Secure provisioning of the external parameter required for AI/ML (e.g., expected UE activity behaviors, expected UE mobility, etc.)

### SUMMARY

It is an object of the present invention to improve the prior art.

According to a first aspect of the invention, there is provided an apparatus comprising means for performing:
checking whether an authorization for performing a federated learning of a model by a terminal is received from a first network element;
monitoring whether a request for the performing the federated learning of the model by the terminal is received; and
prohibiting the performing the federated learning of the model by the terminal if at least one of:
   the authorization for the federated learning of the model by the terminal is not received, and
   the request for the performing the federated learning of the model by the terminal is not received.

According to a second aspect of the invention, there is provided an apparatus comprising means for performing:
monitoring if a request for authorizing performing federated learning of a first model by a terminal is received from an application function, wherein the request comprises a requirement on a resource of the terminal or on data on the terminal for the performing the federated learning of the first model by the terminal;
checking whether the requirement fits to a relevant limitation for the performing the federated learning of the first model by the terminal if the request is received; and
refusing the authorizing the performing the federated learning of the first model by the terminal if the requirement does not fit the relevant limitation.

According to a third aspect of the invention, there is provided an apparatus comprising means for performing:
monitoring whether a database receives an overall limitation for performing federated learning of any model by a terminal;
storing the overall limitation in the database if the overall limitation is received;
supervising whether the database receives a request to provide a first limitation for performing federated learning of a first model by the terminal; and
providing the first limitation in response to the receiving the request, wherein the first limitation comprises at least one of the overall limitation and a relevant limitation for performing federated learning of the first model by the terminal, and the relevant limitation is based on the overall limitation.

According to a fourth aspect of the invention, there is provided a method comprising:
checking whether an authorization for performing a federated learning of a model by a terminal is received from a first network element;
monitoring whether a request for the performing the federated learning of the model by the terminal is received; and
prohibiting the performing the federated learning of the model by the terminal if at least one of:
   the authorization for the federated learning of the model by the terminal is not received, and
   the request for the performing the federated learning of the model by the terminal is not received.

According to a fifth aspect of the invention, there is provided a method comprising:
monitoring if a request for authorizing performing federated learning of a first model by a terminal is received from an application function, wherein the request comprises a requirement on a resource of the terminal or on data on the terminal for the performing the federated learning of the first model by the terminal;
checking whether the requirement fits to a relevant limitation for the performing the federated learning of the first model by the terminal if the request is received; and
refusing the authorizing the performing the federated learning of the first model by the terminal if the requirement does not fit the relevant limitation.

According to a sixth aspect of the invention, there is provided a method comprising:
monitoring whether a database receives an overall limitation for performing federated learning of any model by a terminal;
storing the overall limitation in the database if the overall limitation is received;
supervising whether the database receives a request to provide a first limitation for performing federated learning of a first model by the terminal; and
providing the first limitation in response to the receiving the request, wherein the first limitation comprises at least one of the overall limitation and a relevant limitation for performing federated learning of the first model by the terminal, and the relevant limitation is based on the overall limitation.

Each of the methods of the fourth to sixth aspects may be a method of federated learning.

According to a seventh aspect of the invention, there is provided a computer readable medium comprising program instructions for causing an apparatus to perform the method according to any one of the fourth to sixth aspects.

According to some embodiments of the invention, at least one of the following advantages may be achieved:
network keeps overall control on authorized learning;
UE keeps control on its involvement in authorized learning.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a message flow according to some example embodiments of the invention;

FIG. 2 shows an apparatus according to an example embodiment of the invention;

FIG. 3 shows a method according to an example embodiment of the invention;

FIG. 4 shows an apparatus according to an example embodiment of the invention;

FIG. 5 shows a method according to an example embodiment of the invention;

FIG. 6 shows an apparatus according to an example embodiment of the invention;

FIG. 7 shows a method according to an example embodiment of the invention; and

FIG. 8 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Some example embodiments of the invention are related to authorization of FL of a model if the FL process is initiated by AF, which may be inside or outside the network to which the UE is attached. For example, if Amazon AF wants to start an FL process at UE, which requires a 10,000 cycles of model transfer between UE and AF, then how will UE authorise the request coming from AF?

As per SA1 AIML study, AIML traffic will increase in near future. Lots of AFs will keep on training the models and push them to UEs for re-training (FL use cases).

### Example: Model-X is Supposed to Consume:

CPU: 0.01% to 0.02%
Memory: <5 MB
Space: 30 MB
   And data:
Image=Yes
Sensor information: No
Audio: No.

If multiple AFs are pushing their models to a UE, even if each model will consume less than 1% CPU, then how will a AF be restricted from having any new models at UE? How coordination will work at multiple AFs? If AF1 is pushing a model to UE1 for 5 hours, and at that time only 1 model is allowed at UE, then how will AF2 get that information? In this regard, how to authorise the AF?

A user owning the device (UE) may have its own preference and criteria (like an entertainment model should not consume images stored in UE, or correspondingly for e.g. sensor information, audio, input to keyboard etc.). Some example embodiments provide a method how the user (UE) can authorize the models coming from different AFs which may consume images (data).

Furthermore, there is a risk that FL learning might be misused. For example, Model-X is supposed to consume certain UE resources (for instance CPU, Memory, Space) and use some specific data (Image, sensor information, audio, input keyboard etc.) for ML model training, but instead, the Model-X is malicious and is collecting additional resources and using additional training data of UE which it is not authorized to.

According to some example embodiments, UE may provide UE resource level preference information to the 5GC. The UE resource level preference information comprises limits to the usage of some resources for FL. The UE may provide the UE resource level preference information via any operator portal. Alternatively, the UE resource level preference information may be stored by AF in the 5GC. In some example embodiments, the UE resource level preference information may be predefined in the 5GC, e.g. for a certain type of UEs and/or a certain type of subscribers.

Some examples of the UE resource level preferences are shown in Table 1:

TABLE 1
Examples of UE resource level preferences

| | Limit | |
|---|---|---|
| | (example): | Description |
| Size | 50 MB to | Model sizes 50 MB to 100 MBs are |
| requirements | 100 MB | allowed at the UE |
| CPU utilization | <=2% | Models expected to take less then |
| | | 2% CPU are allowed to access UEs |
| Max Time | 5 hours | Only 5 hours of FL are allowed at |
| duration | | the UE |
| Threshold battery | 10% | When battery reaches 10% or less, |
| indication | | then no model transfer is allowed |
| | | to UE |
| Max model | 1 | Only 1 model transfer or FL is |
| transfers or FLs | | allowed at a time |
| at a time | | |
| etc | | |

In some example embodiments, UE provides limitations to data access to 5GC. Such restriction may be related e.g. to voice, video, camera, SMS, input to keyboard, etc. The UE may provide the data access limitation via any operator portal. Alternatively, the data access limitation may be stored by AF in the 5GC. In some example embodiments, the data access limitations may be predefined in the 5GC, e.g. for a certain type of UEs and/or a certain type of subscribers.

In some example embodiments, the limitation (for resources and/or for data access) may depend on the category of the model used for FL (Model Category preference information). Model Category preference information is provided to the 5GC via any operator portal. Alternatively, UE Model Category preference information may be stored by AF in the 5GC. In some example embodiments, the Model Category preference information may be predefined in the 5GC, e.g. for a certain type of UEs and/or a certain type of subscribers.

Table 2 shows an example of Model category preference information for data access:

TABLE 2
Example of Model category preference information for data access

| | Voice | Video | Image on | SMS | |
|---|---|---|---|---|---|
| | access | access | the devices | access | |
| Model Category | allowed? | allowed? | allowed? | allowed? | Description |
| Entertainment | Yes | No | No | No | Entertainment |
| | | | | | category models |
| | | | | | are allowed to |
| | | | | | access only |
| | | | | | Voice at the UE. |
| | | | | | They can not |
| | | | | | access Video, |
| | | | | | Image and SMS |
| | | | | | on the UE |
| Network | Yes | Yes | Yes | Yes | |
| improvement | | | | | |
| User | . . . | . . . | . . . | . . . | |
| experience | | | | | |
| improvement | | | | | |
| on Cat-X | | | | | |
| Use case Cat-Y | Yes | Yes | Yes | Yes | |
| Default | . . . | . . . | . . . | . . . | In case of no |
| | | | | | specific |
| | | | | | category, UE can |
| | | | | | also provide its |
| | | | | | preference in |
| | | | | | general, which is |
| | | | | | then applicable |
| | | | | | all the categories |

Tables 1 and 2 just provide non-limiting examples. More categories or custom categories are possible based on use cases. For example, if UE is an IoT device, then new categories can be defined.

This UE resource level preferences, data access limitations, and/or model category preference information (hereinafter summarized as “UE limitation”) may be stored in UDR/UDM or in any other suitable database, such as a dedicated database for FL.

When AF wants to send a model for FL to UE, it provides model characteristics to the 5G core/FL server (e.g. model size, expected number of cycles, FL process time duration, local size of the model that UE returns, UE identity(s) involved in the FL process, model category, UE data needed for model training and so on). If the AF is external from the network, the request is typically sent to NEF but it may be sent to any NF handling FL aspects, such as FL server.

5GC (represented by e.g. FL server or NEF) may authorize the request based on UE limitation stored e.g. in UDM/UDR or any other DB (such as ADRF). E.g., if the present request is the only request for performing FL on the UE and if the model characteristics fit to the UE limitation, 5GC accepts the request, otherwise it rejects the request. If 5GC accepts the request, 5GC stores the model characteristics and time at which the FL process starts where UE resources will be involved.

### Example of Model Characteristics Stored in 5GC:

Model X, AF-ID
FL process time (Example, 10 AM to 3 PM on day X).
CPU/Memory requirements of the model

If a second AF wishes to perform FL (or the first AF wishes to perform FL of another model) and the number of models to be executed in parallel is 1, the 5G core must reject the request, as authorization has failed. I.e., if maximum number of models for FL at a time is set to 1 at the UE limitation and one FL process is going on and a second AF requests performing an FL process for another model, then 5G core shall reject the request.

In some example embodiments, 5GC keeps track of authorized FL learning for the UE. I.e., it deducts the resources assigned for an authorized ML learning from the respective UE limitation. Only the remaining portion of the UE limitation is relevant for the next request for FL for the same time. This new limitation may be called a relevant limitation. For example, if the UE limitation for CPU usage for ML is 1%, and a first request for ML is authorized and requires 0.3% of CPU usage, the relevant limitation for a following request for FL of another model is 0.7% of CPU usage. In 5GC, keeping track of authorized learning of the models by the UE and calculating the relevant limitation may be performed e.g. by NEF/FLF and/or by UDM/ADRF. In the latter case, UDM/ADRF is informed by NEF/FLF on the granted authorizations for FL or each model by the UE and the resources assigned to FL of these models. In response to a request from NEF/FLF, UDM/ADRF may provide the relevant limitation with or without the overall UE limitation.

If any change occurs at the AF (like AF wants to change FL time), the AF should ask at 5GC for updated authorization.

If 5GC accepts the request, it informs the UE accordingly. In addition, depending on implementation, it may inform the requesting AF accordingly. 5GC may inform UE about the authorization via NAS (NAS container) or UPU procedure (or another procedure, which is preferably secured). The information to UE may comprise at least the model ID. Typically, it may comprise:
AF ID
Model ID
Time (e.g. start time and end time, or start time and duration).
Model characteristics (for instance what UE training data model is allowed to use)

The UE may save this information and use it to approve or deny a request received from AF for federated learning of a model. Namely, the request may comprise the relevant information (at least the model ID). The UE compares this information in the request with the stored information. If corresponding information is not stored in the UE, the UE rejects the request.

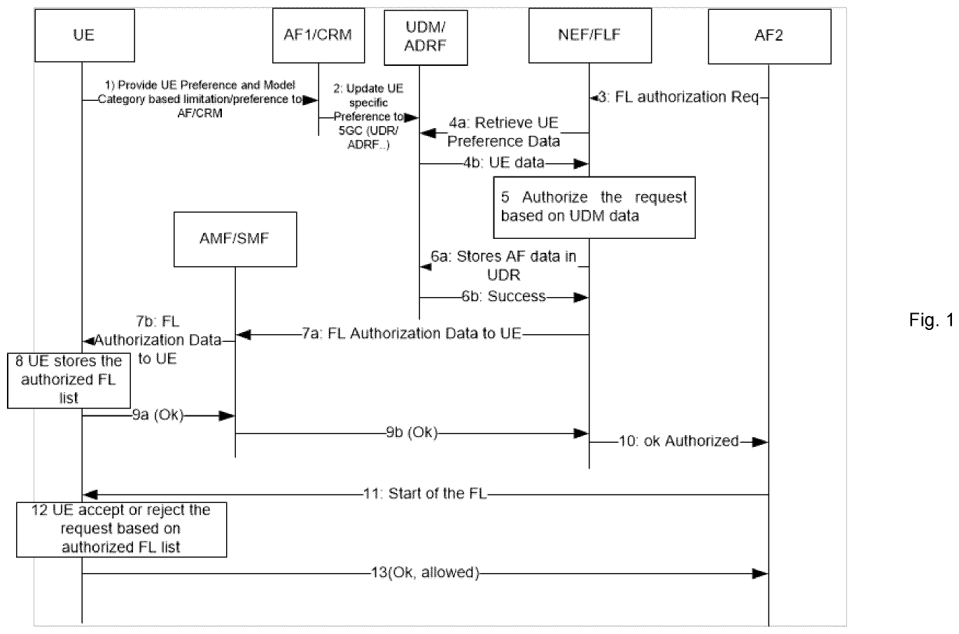

FIG. 1 shows a message sequence chart according to some example embodiments of the invention. The actions in FIG. 1 are as follows:

Actions 1,2: UE provides its UE limitations (resources, data access, and or model categories) via portal, IVR or SMS etc. (represented as AF1/CRM in FIG. 1) to 5G core. 5GC stores the information in a DB, such as UDM/UDR or ADRF.

Action 3: AF2 wants to transfer a model for FL to UE. Therefore, the AF2 asks for authorization by 5GC. This request for authorization includes the relevant model characteristics. In FIG. 1, 5GC receives the request for authorization at network exposure function (NEF) or at a new federated learning network function (FLF). In some example embodiments, the FLF may be hosted by another network function, such as NEF. In FIG. 1 and related description, the authorizing network function is denoted NEF/FLF.

Action 4: NEF/FLF retrieves the UE limitation and information on already authorized FL learning for the UE (as will be updated in Action 6) from UDM/ADRF. Thus, it may calculate the relevant limitation for authorizing the FL request.

Action 5: NEF/FLF checks if the requirements for the FL learning requested by AF2 fit to the relevant limitation. If yes, NEF/FLF authorizes the request, as shown in the example of FIG. 1.

Action 6: Once the request is authorized, the NEF/FLF stores the authorization information (in particular: the requirements for the FL) to UDM/ADRF. This information will be helpful for further authorizing a new request for performing FL by the UE. E.g., if only 1 FL at a time is allowed at UE, the NEF/FLF shall reject a request coming from another AF asking for authorization for performing another FL at the same time.

Action 7: NEF/FLF pushes information on the authorized FL to UE. The information comprises at least a model ID, and may comprise further information on the requesting AF (AF2) and the requirements. For example, NEF/FLF may provide this information to UE via a NAS container, i.e. NEF/FLF asks SMF, and SMF provides the information to UE via NAS. As another option, the information on the authorized FL may be integrity protected via UPU and passed to UE. In addition, not shown in FIG. 1, NEF/FLF may inform AF directly on the authorization (instead of or in addition to Action 10).

Actions 8, 9: UE stores the information on the authorized FL (e.g. in an “authorized FL list”) and sends a response (“ok”) back to 5GC represented by NEF/FLF.

Action 10: NEF/FLF sends a response back to AF2, thus informing the AF2 that the request for performing FL on the UE is authorized.

Action 11: AF2 requests UE to start FL. For that purpose, AF2 provides the authorized information (Model Id, time window, training data to be used, etc.) to UE.

Actions 12, 13: UE checks if the information received from AF2 fits the information stored in the authorized FL list updated according to Action 8. If the received information fits the information stored in the authorized FL list, then the UE allows the FL process and informs the AF2 accordingly, as shown in FIG. 1. Otherwise, UE rejects the request. I.e., if Model Id related information is not available in the authorized FL list at the UE, the UE rejects the request (not shown in FIG. 1).

In some example embodiments, UE monitors the resource usage of the federated learning of the model against the information from Action 7 (stored in the UE in Action 8) if the information comprises the requirements. In case of any misuse (i.e., if the federated learning of the model uses more resources than authorized, or uses some other resource than one of those it is authorized to use according to the requirements, UE can discard the federated learning of the model during the runtime.

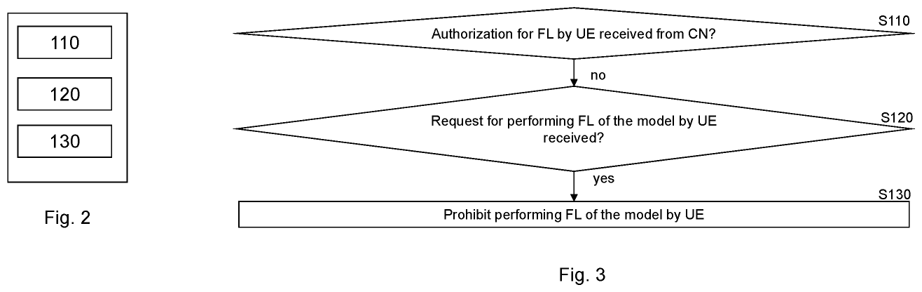

FIG. 2 shows an apparatus according to an example embodiment of the invention. The apparatus may be a terminal, such as a UE, an MTC device, or an IoT device, or an element thereof. FIG. 3 shows a method according to an example embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises means for checking 110, means for monitoring 120, and means for prohibiting 130. The means for checking 110, means for monitoring 120, and means for prohibiting 130 may be a checking means, monitoring means, and prohibiting means, respectively. The means for checking 110, means for monitoring 120, and means for prohibiting 130 may be a checker, monitor, and prohibitor, respectively. The means for checking 110, means for monitoring 120, and means for prohibiting 130 may be a checking processor, monitoring processor, and prohibiting processor, respectively.

The means for checking 110 checks whether an authorization for federated learning of a model by a terminal is received from a core network (S110). The means for monitoring 120 monitors whether a request for performing the federated learning of the model by the terminal is received (S120). S110 and S120 may be performed in an arbitrary sequence. They may be performed fully or partly in parallel. FIG. 3 shows an example, where the checking S110 is performed prior to the monitoring S120, and where the result of the checking S110 is negative, while the result of the monitoring S120 is positive. I.e., for example, the UE receives a request for the performing the federated learning (S120=yes) although a respective authorization is not received (S110=no).

If at least one of the following conditions is satisfied:
the authorization for the federated learning of the model by the terminal is not received (S110=no), and
the request for the performing the federated learning of the model by the terminal is not received (S120=no),
   the means for prohibiting 130 prohibits the performing the federated learning of the model by the terminal (S130). Otherwise, a means for instructing may instruct the performing the federated learning of the model by the terminal.

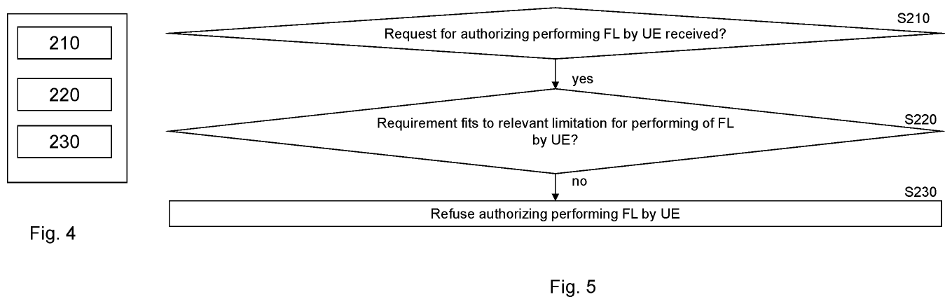

FIG. 4 shows an apparatus according to an example embodiment of the invention. The apparatus may be a core network, or a function representing the core network, such as a NEF or an FL server, or an element thereof. FIG. 5 shows a method according to an example embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises means for checking 220, means for monitoring 210, and means for refusing 230. The means for checking 220, means for monitoring 210, and means for refusing 230 may be a checking means, monitoring means, and refusing means, respectively. The means for checking 220, means for monitoring 210, and means for refusing 230 may be a checker, monitor, and refuser, respectively. The means for checking 220, means for monitoring 210, and means for refusing 230 may be a checking processor, monitoring processor, and refusing processor, respectively.

The means for monitoring 210 monitors if a request for authorizing performing federated learning of a model by a terminal is received (S210). The request comprises a requirement on a resource of the terminal or on data on the terminal for the performing the federated learning of the first model by the terminal. The request may be received from an application function.

If the request is received (S210=yes), the means for checking 220 checks whether the requirement fits to a relevant limitation for the performing the federated learning of the model by the terminal (S220).

If the requirement does not fit the relevant limitation (S220=no), the means for refusing 230 refuses the authorizing the performing the federated learning of the model by the terminal (S230). Otherwise, the performing the federated learning of the model by the terminal may be authorized.

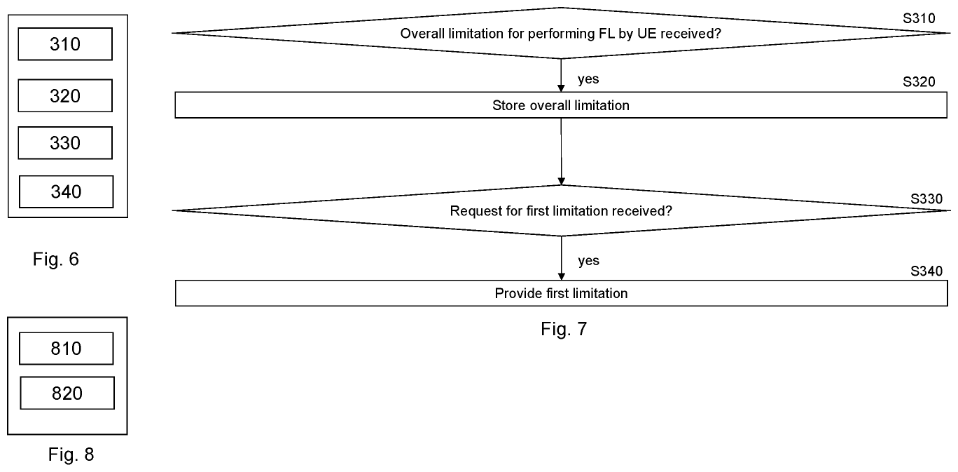

FIG. 6 shows an apparatus according to an example embodiment of the invention. The apparatus may be a database, such as a UDM or ADRF, or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for monitoring 310, means for storing 320, means for supervising 330, and means for providing 340. The means for monitoring 310, means for storing 320, means for supervising 330, and means for providing 340 may be a monitoring means, storing means, supervising means, and providing means, respectively. The means for monitoring 310, means for storing 320, means for supervising 330, and means for providing 340 may be a monitor, storage device, supervisor, and provider, respectively. The means for monitoring 310, means for storing 320, means for supervising 330, and means for providing 340 may be a monitoring processor, storing processor, supervising processor, and providing processor, respectively.

The means for monitoring 310 monitors whether a database (e.g. UDM or ADRF) receives an overall limitation for performing federated learning of any model by a terminal (S310). If the overall limitation is received (S310=yes), the means for storing 320 stores the overall limitation in the database (S320).

The means for supervising 330 supervises whether the database receives a request to provide a first limitation (S330). The first limitation is for performing federated learning of a first model by the terminal. If the request is received (S330=yes), the means for providing 340 provides the first limitation in response to the receiving the request (S340). The first limitation comprises at least one of the overall limitation and a relevant limitation for performing federated learning of the first model by the terminal. The relevant limitation is based on the overall limitation. In detail, the relevant limitation may be calculated based on the overall limitation by subtracting resources that have been assigned to federated learning of other models than the first model.

FIG. 8 shows an apparatus according to an example embodiment of the invention. The apparatus comprises at least one processor 810, at least one memory 820 including computer program code, and the at least one processor 810, with the at least one memory 820 and the computer program code, being arranged to cause the apparatus to at least perform at least the method according to at least one of FIGS. 3, 5, and 7 and related description.

Some example embodiments are explained with respect to a 5G network. However, the invention is not limited to 5G. It may be used in other communication networks, too, e.g. in previous of forthcoming generations of 3GPP networks such as 4G, 6G, or 7G, etc. It may be used in non-3GPP communication networks, too.

The functions of the 5GC (e.g. NEF, UDM etc.) indicated hereinabove are examples only. The function split may be different from that described. In particular, some or all of the actions of the 5GC may be performed by a dedicated function for the respective purpose, or another existing function may take over some or all of these actions.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, an terminal, such as a UE or a MTC device, or a component thereof, an apparatus embodying the same, a method for controlling and/or operating the same, and computer program(s) controlling and/or operating the same as well as mediums carrying such computer program(s) and forming computer program product(s).

According to the above description, it should thus be apparent that example embodiments of the present invention provide, for example, a core network function such as a AF, CRM, UDM, ADRF, or NEF, or a component thereof, or a combination of these core network functions, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention defined by the appended claims.

The phrase “at least one of A and B” comprises the options only A, only B, and both A and B. The terms “first X” and “second X” include the options that “first X” is the same as “second X” and that “first X” is different from “second X”, unless otherwise specified.

1-62. (canceled)

63. An apparatus comprising:
at least one processor; and
at least one memory storing instructions that, when executed by the at least one processor, cause the apparatus at least to perform:
checking whether an authorization for performing a federated learning of a model by a terminal is received from a first network element;
monitoring whether a request for the performing the federated learning of the model by the terminal is received; and
prohibiting the performing the federated learning of the model by the terminal if at least one of:
the authorization for the federated learning of the model by the terminal is not received, and
the request for the performing the federated learning of the model by the terminal is not received.

64. The apparatus according to claim 63, further configured to perform:
instructing the performing the federated learning of the model if the authorization for the federated learning of the model is received and the request for the federated learning of the model is received.

65. The apparatus according to claim 64, further configured to perform:
providing a limitation for the performing the federated learning of the model to a first application function.

66. The apparatus according to claim 65, wherein the limitation comprises at least one of a limitation of a proportion of a first resource to be used for the federated learning of the model and a limitation of an access to data on the terminal to be used for the federated learning of the model.

67. The apparatus according to claim 65, wherein the limitation is related to a category of the model.

68. The apparatus according to claim 65, further configured to perform:
monitoring whether the performing the federated learning of the model violates the limitation; and
discarding the performing the federated learning of the model if the performing the federated learning of the model violates the limitation.

69. The apparatus according to claim 63, wherein the authorization indicates that a second application function is authorized to request the performing the federated learning of the model, and wherein the means are further configured to perform:
informing the second application function that the authorization is received.

70. The apparatus according to claim 63, further configured to perform:
informing a third application function that the performing the federated learning is prohibited if the request for the performing the federated learning of the model by the terminal is received from the third application function and the authorization for performing the federated learning of the model by the terminal is not received from the first network element.

71. The apparatus according to claim 63, wherein the checking comprises checking whether the authorization is received from the first network element via a non-access stratum container or as parameter update data for the terminal.

72. The apparatus according to claim 63, wherein the first network element comprises an access and mobility management function, AMF, or a session management function, SMF.

73. The apparatus according to claim 63, wherein the apparatus is included in the terminal, or the apparatus is the terminal.

74. An apparatus comprising:
at least one processor; and
at least one memory storing instructions that, when executed by the at least one processor, cause the apparatus at least to perform:
monitoring if a request for authorizing performing federated learning of a first model by a terminal is received from an application function, wherein the request comprises a requirement on a resource of the terminal or on data on the terminal for the performing the federated learning of the first model by the terminal;
checking whether the requirement fits to a relevant limitation for the performing the federated learning of the first model by the terminal if the request is received; and
refusing the authorizing the performing the federated learning of the first model by the terminal if the requirement does not fit the relevant limitation.

75. The apparatus according to claim 74, further configured to perform:
authorizing the performing the federated learning of the first model by the terminal if the requirement fits the relevant limitation; and
informing the terminal that the performing the federated learning of the first model is authorized if the requirement fits the relevant limitation.

76. An apparatus comprising:
at least one processor; and
at least one memory storing instructions that, when executed by the at least one processor, cause the apparatus at least to perform:
monitoring whether a database receives an overall limitation for performing federated learning of any model by a terminal;
storing the overall limitation in the database if the overall limitation is received;
supervising whether the database receives a request to provide a first limitation for performing federated learning of a first model by the terminal; and
providing the first limitation in response to the receiving the request, wherein the first limitation comprises at least one of the overall limitation and a relevant limitation for performing federated learning of the first model by the terminal, and the relevant limitation is based on the overall limitation.

77. The apparatus according to claim 76, wherein:
the overall limitation comprises at least one of: an overall proportion of a resource to be used in total for performing the federated learning of any models by the terminal; and a limitation of an access to the data to be accessed for the performing the federated learning of any models by the terminal.
